(19) United States
(12) Patent Application Publication
(10) Pub. No.: US 2026/0288989 A1
(43) Pub. Date: Sep. 24, 2026

(54) MANAGING ACCESS TO DATA USING A MANAGEMENT CONTROLLER OF A DATA PROCESSING SYSTEM

(71) Applicant: Dell Products L.P., Round Rock, TX (US)

(72) Inventors: IBRAHIM SAYYED, Georgetown, TX (US); ADOLFO SANDOR MONTERO, Pflugerville, TX (US); XIAOMEI ZHU MILLER, Round Rock, TX (US); PHANINDRA BHARGAV TALASILA, Georgetown, TX (US)

(21) Appl. No.: 19/085,583

(22) Filed: Mar. 20, 2025

(51) Int. Cl. G06F 21/62

(52) U.S. Cl. CPC G06F 21/6218; G06F 21/575; G06F 21/62; G06F 9/4401; G06F 9/4406; G06F 2221/2141

(57) ABSTRACT

Methods and systems for managing operations of a data processing system are disclosed. To manage operations of the data processing system, a management controller may obtain a request from an entity hosted by hardware resources to perform an operation with respect to at least a portion of boot data stored in a storage device. The management controller may perform a permission analysis process for the entity to determine whether the entity is authorized to initiate performance of the operation with respect to the at least the portion of the boot data. If the entity is authorized, the management controller may facilitate performance of the operation to facilitate provisioning of computer-implemented services by the data processing system.

### FIELD

Embodiments disclosed herein relate generally to managing operation of a data processing system. More particularly, embodiments disclosed herein relate to systems and methods to manage access to data using a management controller of a data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show block diagrams illustrating a system in accordance with an embodiment.

FIGS. 2A-2C show interaction diagrams in accordance with an embodiment.

FIG. 3 shows a flow diagram illustrating a method of managing a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may include hardware resources and/or software components that, in some combination, may be used to provide computer-implemented services. To provide the computer-implemented services, the data processing system may undergo a booting process (e.g., a startup) during which functionality of a portion of its hardware resources and/or software components may be enabled.

To perform the booting process, a processor (e.g., a central processing unit (CPU)) of the hardware resources may utilize boot data (e.g., basic input/output system (BIOS) firmware, system configuration files, etc.) that may be stored in a storage device of the data processing system. The storage device may include a non-volatile memory express (NVMe) solid-state drive. Using the boot data, the data processing system may be placed in a desired operating state to provide the computer-implemented services.

However, if any of the hardware components of the hardware resources become compromised, the boot data stored in the storage device may be modified in an undesirable manner. For example, the boot data may be modified to include malicious code, undesired code, erroneous code, unauthorized code, etc., which may result in the operation of the data processing system diverging from the desired operating state. Consequently, the data processing system may be unable to provide a portion of the computer-implemented services, and/or the computer-implemented services may be otherwise negatively impacted.

To reduce a likelihood of the boot data being modified in an undesirable manner, the data processing system may include out-of-band components such as a management controller. The management controller may be distinct from and adapted to manage the hardware resources of the data processing system. The management controller may cooperatively establish a boot partition with the storage device and the management controller may manage the boot partition. The boot partition may include a portion of storage resources of the storage device in which boot data (and/or other types of data) is stored. By managing the boot partition, the management controller may limit, restrict, and/or otherwise control access of entities to the boot data (e.g., based on a schema, policy, rule set, etc. usable to determine permissions of entities to access the boot data). As a result, a likelihood of undesirable modification of the boot data may be reduced, and computer-implemented services provided by the data processing system may be provided to downstream consumers of the services as desired.

For example, to perform an operation with respect to at least a portion of the boot data, an entity may provide a request to the management controller. The management controller may then perform a permission analysis process to determine whether the entity is authorized to initiate performance of the operation with respect to the at least the portion of the boot data. If the entity is authorized, the management controller may facilitate performance of the operation to facilitate provisioning of the computer-implemented services by the data processing system. If the entity is not authorized, the management controller may prevent the entity from performing the operation. A request provided by the entity to the storage device may be denied by the storage device (e.g., only the management controller may be permitted by the storage device to access the boot data).

Thus, embodiments disclosed herein may address, among other technical problems, the technical challenge of controlling access to data (e.g., boot data) stored in a storage device of a data processing system. By using out-of-band components such as a management controller to limit, restrict, and/or otherwise control access to the boot data based on data access limitations, a likelihood that the boot data is accessed by unauthorized entities may be reduced. As a result, the boot data and data processing system may be less likely to become compromised, and computer-implemented services provided by the data processing system may be provided as desired.

In an embodiment, a method for managing operation of a data processing system is disclosed. The method may include: obtaining, by a management controller of the data processing system and from an entity hosted by hardware resources of the data processing system, a request to perform an operation with respect to at least a portion of boot data stored in a storage device of the hardware resources; performing, by the management controller, a permission analysis process for the entity to determine whether the entity is authorized to initiate performance of the operation with respect to the at least the portion of the boot data; and in an instance of the performing in which the entity is authorized to initiate performance of the operation: facilitating, by the management controller, performance of the operation with respect to the at least the portion of the boot data to facilitate provisioning of computer-implemented services by the data processing system.

Performing the permission analysis process may include: obtaining, by the management controller and via a side band channel of the data processing system, at least one characteristic for the entity; making, by the management controller, a determination regarding whether the entity is authorized to perform the operation based on at least the at least one characteristic, the operation, the at least the portion of the boot data, and data access limitations for data stored in the storage device.

The data access limitations may be managed by the management controller, and may include a schema usable to determine permissions of entities to perform operations with respect to portions of the boot data.

The boot data may be stored in a boot partition of the storage device, the boot partition being a portion of storage resources of the storage device allocated for storage of boot data.

The boot partition may be cooperatively established by the management controller and the storage device.

The management controller may be permitted by the storage device to access the boot partition and no other entity of the data processing system may be permitted by the storage device to access the boot partition.

The operation may include at least one type of operation selected from a list consisting of: reading the at least the portion of the boot data from the boot partition; and writing the at least the portion of the boot data to the boot partition.

Facilitating performance of the operation with respect to the at least the portion of the boot data may include: obtaining, by the management controller and via a first side band channel of the data processing system, the at least the portion of the boot data from the entity to facilitate writing the at least the portion of the boot data to the boot partition; and providing, by the management controller and via a second side band channel of the data processing system, the at least the portion of the boot data to the storage device.

The method may also include: in an instance of the performing in which the entity is not authorized to initiate performance of the operation with respect to the at least the portion of the boot data: preventing, by the management controller, the entity from initiating performance of the operation with respect to the at least the portion of the boot data.

The entity may not be permitted by the storage device to access the boot data, and requests to perform operations with respect to portions of the boot data obtained by the storage device from the entity may be denied by the storage device.

The management controller may operate independently from and may be distinct from the hardware resources.

The storage device may be a non-volatile memory express (NVMe) solid-state drive.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

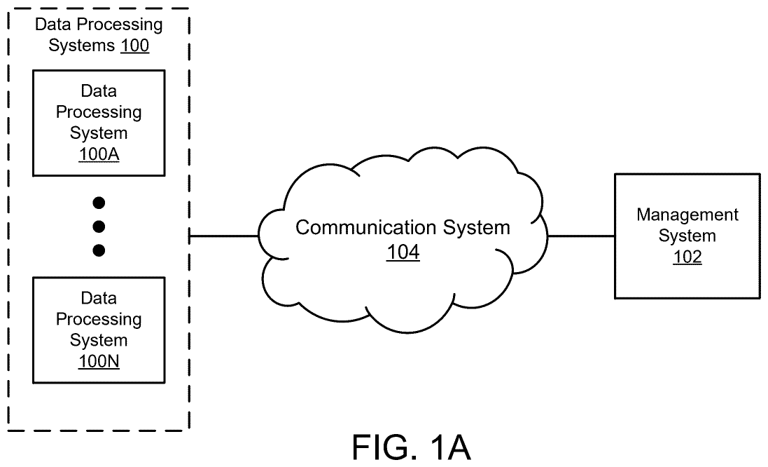

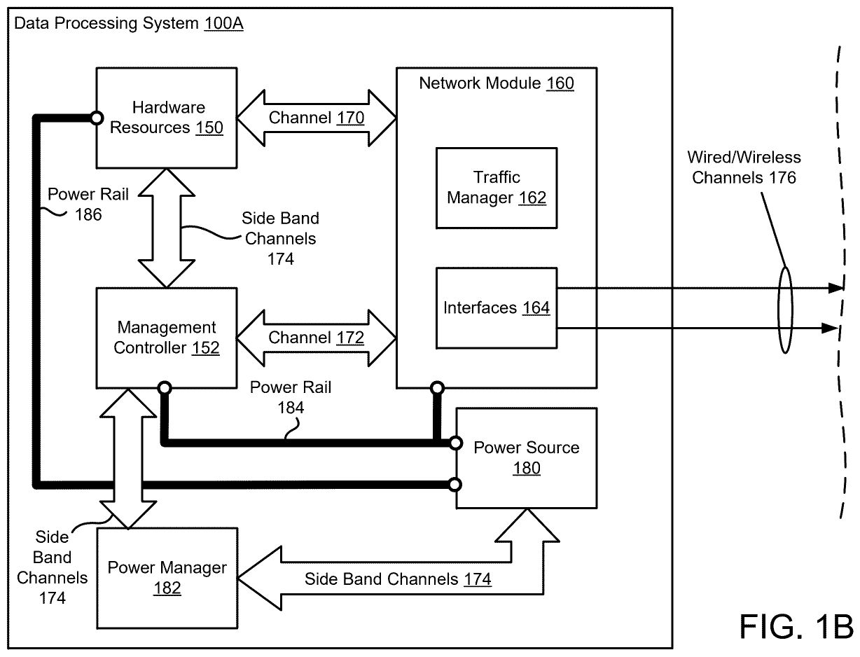

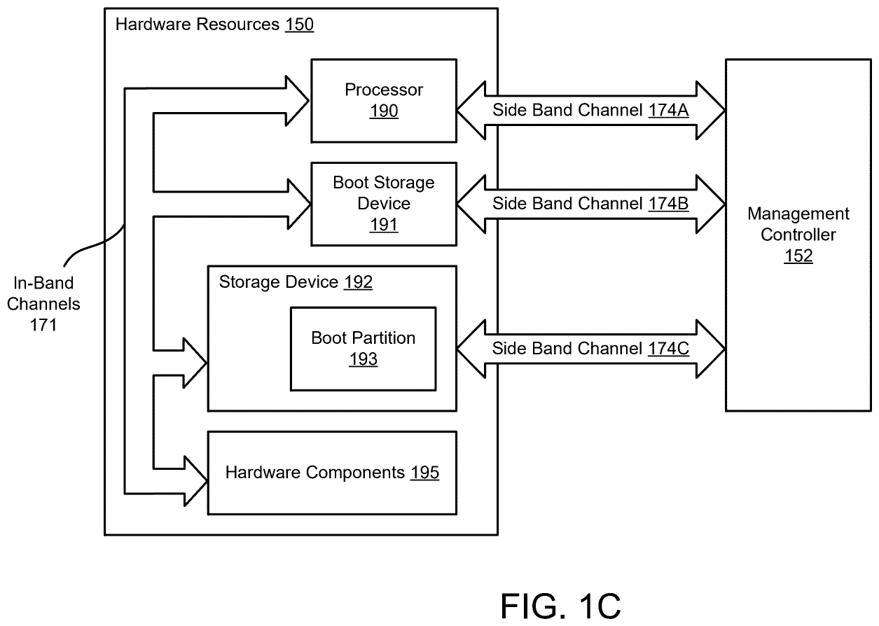

Turning to FIG. 1A, a block diagram illustrating a system in accordance with an embodiment is shown. The system shown in FIG. 1A may provide for management of any number of data processing systems (e.g., 100A-100N) that may provide, at least in part, computer-implemented services (e.g., to users of the system and/or devices operably connected to the system). The computer-implemented services may include any type and quantity of services including, for example, data services (e.g., data storage, access, and/or control services), communication services (e.g., instant messaging services, video-conferencing services), and/or any other type of service that may be implemented with a computing device. Other types of computer-implemented services may be provided by the system shown in FIG. 1A without departing from embodiments disclosed herein.

To provide the computer-implemented services, each data processing system may include hardware resources including hardware components (e.g., processors, memory modules, storage devices, communication devices, etc.). The hardware components may support execution of any number and type of applications (e.g., software components). Changes in available functionalities of the hardware and/or software components may provide for various types of different computer-implemented services to be provided over time. Refer to FIG. 1B-1C for additional details regarding data processing systems 100.

In order to provide the computer-implemented services, a data processing system (e.g., 100A) may perform a booting process (e.g., a startup) to initialize operation of the hardware components. To do so, a processor (e.g., a central processing unit (CPU)) of the hardware components may utilize boot data (e.g., basic input/output system (BIOS) firmware, system configuration files, etc.) that may be stored on a storage device. The storage device may include, for example, a non-volatile memory storage device (e.g., serial peripheral interface flash) and/or a non-volatile memory express (NVMe) solid-state drive.

By performing the booting process, the hardware components of the data processing system may be operably connected to each other (e.g., via in-band channels) and an operating system (and/or other management entity) may be loaded to provide management functionality. In doing so, the data processing system may be placed in a desired operating state to provide the computer-implemented services.

However, if any of the hardware components become compromised, the boot data stored in the storage device may be modified in an undesirable manner. For example, the boot data may be modified to include malicious code, undesired code, erroneous code, unauthorized code, etc., which may result in the operation of the data processing system diverging from the desired operating state.

For example, the storage device may be accessed by a malicious entity, and malicious files may be added to the boot data. The malicious files may allow the malicious entity to access sensitive data stored on the data processing system, boot malicious devices during startups of the data processing system, prevent authorized users from using the data processing system, and/or otherwise compromise the data processing system. Compromise of the data processing system by the malicious entity may result in the computer-implemented services provided by the data processing system being interrupted, delayed, and/or of a reduced quality.

In general, embodiments disclosed herein may provide methods, systems, and/or devices for managing operation of a data processing system in a manner that improves resiliency of the data processing system to compromise. To do so, the data processing system may include out-of-band resources such as a management controller. The management controller may be distinct from and adapted to manage the hardware resources of the data processing system. For example, the management controller may manage a portion of storage resources of a storage device of the data processing system in which boot data (and/or other types of data) is stored. By managing the portion of the storage resources, the management controller may limit, restrict, and/or otherwise control access of entities to the boot data. As a result, a likelihood of compromise of the boot data may be reduced.

To do so, the management controller may cooperatively establish a boot partition with the storage device. The boot partition may include a portion of storage resources of the storage device allocated for storage of boot data. The management controller may be permitted by the storage device to access the boot partition, and no other entity of the data processing system may be permitted by the storage device to access the boot partition. For example, if an entity that is not the management controller provides a request to the storage device to read a portion of the boot data, the storage device may deny the request.

To perform operations with respect to portions of the boot data (e.g., reading boot data, writing boot data) by entities hosted by hardware resources of the data processing system (e.g., software programs), the entities may provide requests to the management controller. The management controller may perform a permission analysis process for the entities to determine whether the entities are authorized to initiate performance of the requested operations. Performance of the operations may be facilitated and/or prevented by the management controller based on results of the permission analysis process.

By doing so, a system in accordance with an embodiment may reduce a likelihood of compromise of the data processing system by using out-of-band components (e.g., a management controller). The management controller may perform a permission analysis process to determine whether entities hosted by hardware resources of the data processing system are authorized to initiate performance of operations with respect to portions of boot data. In doing so, access to the boot data may be controlled via out-of-band methods, which may be more resistant to becoming compromised and/or disabled (e.g., by a malicious entity). As a result, a likelihood of the data processing system being compromised may be reduced, and computer-implemented services provided by the data processing system may be provided to downstream consumers of the services as desired.

To perform the above-mentioned functionality, the system of FIG. 1A may include data processing systems 100, and/or management system 102. Data processing systems 100, management system 102, any components thereof and/or any other types of devices or components not shown in FIG. 1A may perform all, or a portion of the computer-implemented services independently and/or cooperatively. Each of these components is discussed below.

Data processing systems 100 may include any number and type of data processing systems (e.g., 100A-100N) that may individually and/or cooperatively provide at least a portion of the computer-implemented services. Any of data processing systems 100 may include in-band components (e.g., hardware resources), out-of-band components (e.g., a management controller), and functionality that may allow the out-of-band components to communicate with management system 102 via an out-of-band communication channel.

While providing the at least the portion of the computer-implemented services, a data processing system (e.g., 100A) of data processing systems 100 may communicate with and/or obtain information from management system 102. For example, a management controller of data processing system 100A may communicate with management system 102 via an out-of-band communication channel. Using the out-of-band communication channel, management system 102 may provide the information to data processing system 100A without traversing potentially compromised in-band communication channels. Doing so may reduce a risk of the information being obtained by a malicious and/or unauthorized entity, being unable to be obtained by data processing system 100A (e.g., due to the in-band components being powered off and/or otherwise inoperable), etc.

For example, the information obtained by the management controller of data processing system 100A from management system 102 may include: (i) instructions and/or data regarding boot data stored by a storage device of the data processing system (e.g., updates and/or other modifications to be made to the boot data, policies for managing boot data), (ii) management requests to modify operation of the hardware resources (e.g., installing new applications), (iii) and/or any other information. The management controller of data processing system 100A may subsequently perform actions based on the information obtained from management system 102 to update operation of data processing system 100A.

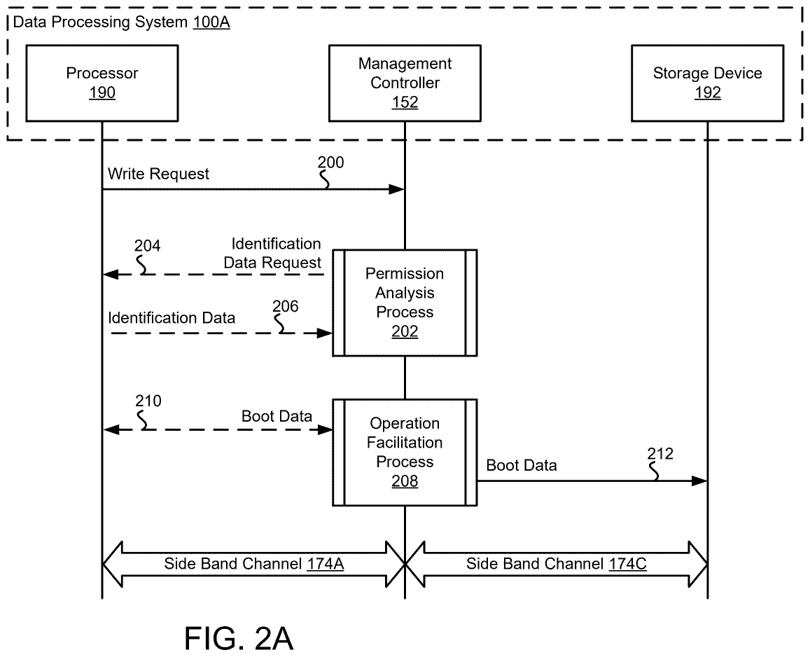

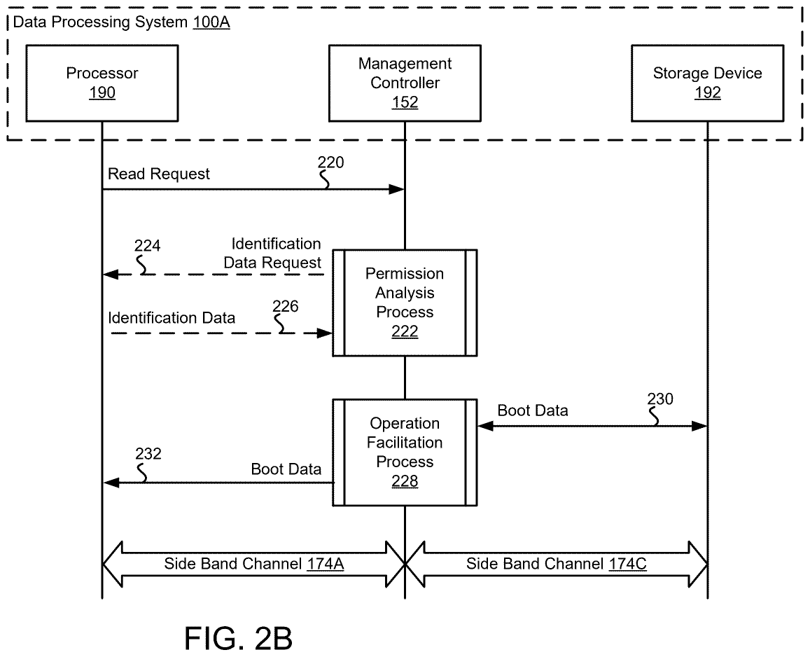

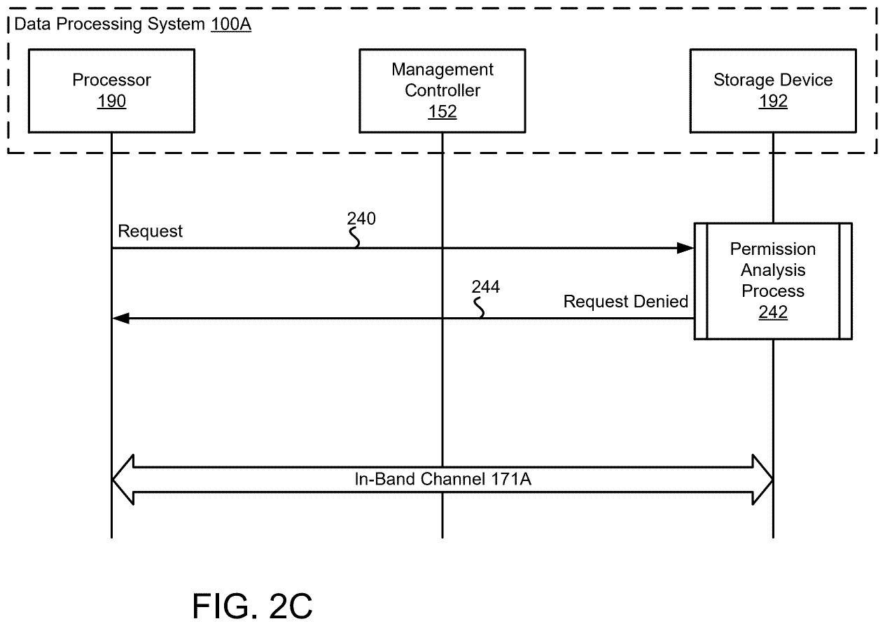

For example, the management controller may obtain a policy from management system 102 for managing access to the boot data. The policy may include data access limitations for the boot data (e.g., a schema, list, and/or rule set for determining whether entities are authorized to initiate performance of operations with respect to portions of the boot data). The management controller may use the policy while performing permission analysis processes for the boot data. As a result, management system 102 and the management controller may collaboratively manage access to the boot data. Refer to the description of FIG. 2A-2B for additional details regarding performing the permission analysis processes by the management controller.

Management system 102 may, as discussed above, provide remote management services for data processing systems 100. Management system 102 may include any number and/or type of devices (e.g., data processing systems) used to interact with data processing systems 100 to obtain and/or provide information (e.g., data) relevant to operation of data processing systems 100. For example, management system 102 may generate and provide the policy to a data processing system of data processing systems 100 for use in managing access to boot data.

Management system 102 may be implemented with multiple computing devices. The computing devices of management system 102 may cooperatively perform processes for managing access to boot data. The computing devices of management system 102 may perform similar and/or different functions, and may be used by different users (e.g., persons) that may participate in the management of boot data.

Management system 102 may be maintained, for example, by a business or other entity that has some degree of responsibility with respect to managing the operation of data processing systems 100. For example, management system 102 may be operated by a manufacturer of data processing systems 100.

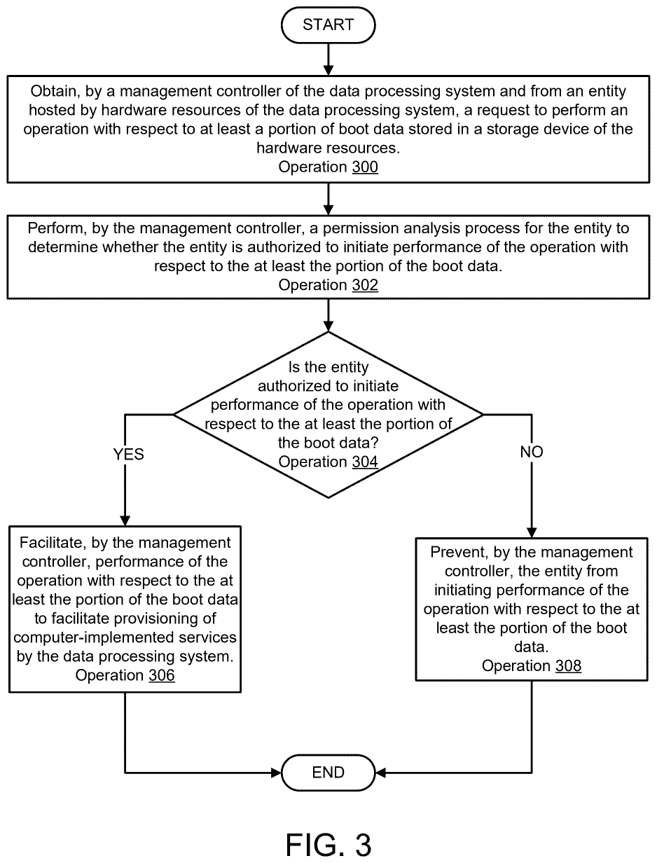

When providing their functionality, any of data processing systems 100 and/or management system 102 may perform all, or a portion of the actions and methods illustrated in FIGS. 2A-3.

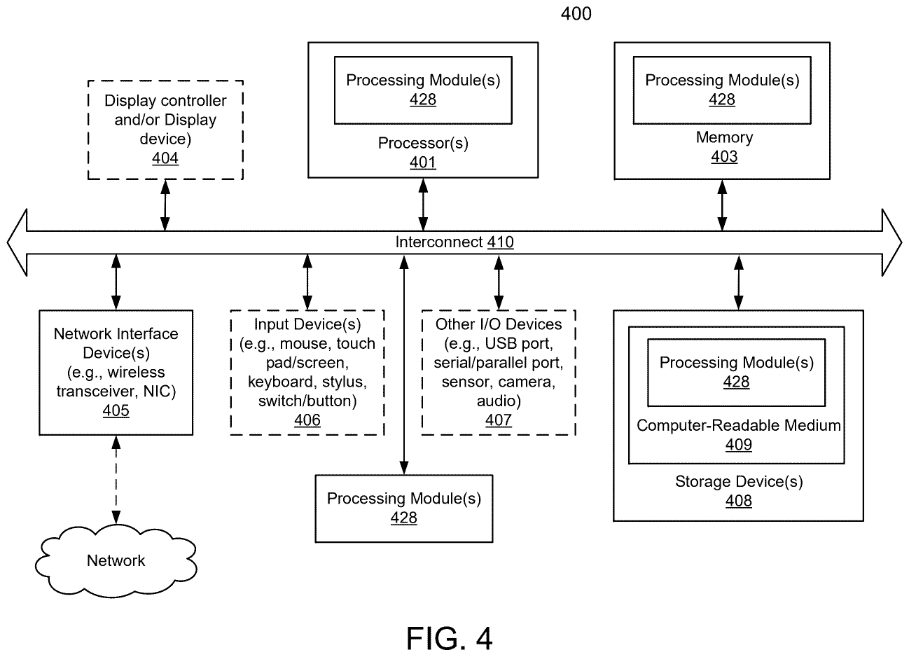

Any of data processing system 100 (and/or components thereof) and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 104. Communication system 104 may facilitate communications between the components of FIG. 1A. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

Thus, as shown in FIG. 1A, a system in accordance with an embodiment may manage operation of a data processing system by using data access limitations (e.g., included as part of a policy) to perform permission analysis processes for boot data (e.g., by a management controller of the data processing system). By doing so, the boot data may have a reduced likelihood of being compromised, which may allow the data processing system to be booted to place the data processing system in a desired operating state.

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 100A shown in FIG. 1B may be similar to any of data processing systems 100 shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express) that may facilitate use of storage resources of the storage device.

For example, the storage may include a first storage device adapted to host an image of a startup management entity (e.g., a basic input/output system (BIOS)), system configurations, and/or any other information. Additionally, the storage may include a second storage device that may include, but not be limited to, storage for information necessary to boot the data processing system, load an operating system for the data processing system, and/or perform any other processes (e.g., boot data).

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band components, may manage power distribution, may provide thermal management services, and/or may perform other functions of data processing system 100A.

To do so, management controller 152 may be operably connected to various components via side band channels 174 (in FIG. 1B, a limited number of side band channels are included for illustrative purposes, it will be appreciated that management controller 152 may communicate with other components via any number of sideband channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

For example, management controller 152 may participate in managing sensitive data (e.g., boot data) stored by a storage device of the data processing system by restricting access to the sensitive data to authorized entities (e.g., based on a policy and/or other type of rule set for identifying permissions of entities). In order to access the sensitive data, an entity of the data processing system (e.g., an application and/or other software component hosted by hardware resources 150) may provide a request to perform an operation with respect to at least a portion of the sensitive data to management controller 152. Management controller 152 may perform a permission analysis process for the entity, and based on a result of the permission analysis process, may facilitate or prevent performance of the operation.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any of management controller 152, entities hosted by management controller 152, and/or data managed by management controller 152 (e.g., the boot data).

To facilitate communication with other devices, data processing system 100A may include network module 160. Network module 160 may provide communication services for in-band components and out-of-band components (e.g., management controller 152) of data processing system 100A. To do so, network module 160 may include traffic manager 162 and interfaces 164.

Traffic manager 162 may include functionality to: (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately power domains, different subsets of these components may remain powered while other subsets are unpowered.

For example, management controller 152 and network module 160 may remain powered while hardware resources 150 is unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3.

While illustrated in FIG. 1B with a limited number of specific components, a system may include additional, fewer, and/or different components without departing from embodiments disclosed herein.

Turning to FIG. 1C, to provide computer-implemented services by a data processing system (e.g., 100A), hardware resources 150 may host processor 190, boot storage device 191, storage device 192, and hardware components 195. Hardware components 195 may include any hardware resources of the data processing system, such as processors, memory modules, storage devices, and/or other types of hardware components usable to provide computer-implemented services.

To provide the computer-implemented services, the data processing system may undergo a booting process (e.g., a startup) to be placed in a desired operating state. During the booting process, hardware resources of the data processing system may be initialized to facilitate operation of an operating system (and/or other management entity of data processing system 100A). To do so, processor 190 may execute instructions indicated by boot data (e.g., firmware, system configurations, etc.). The boot data may be hosted by boot storage device 191 and/or storage device 192.

Boot storage device 191 may include, for example, non-volatile flash memory (e.g., serial peripheral interface (SPI) flash) that may be hosted on a motherboard and adapted to store information, such as firmware, an image of a management entity (e.g., BIOS, universal extensible firmware interface (UEFI), etc.), system configuration files, and/or any other boot data usable to perform startups for data processing system 100A. Because boot storage device 191 may have a limited storage capacity, storage device 192 may be used to store additional information (e.g., other boot data, copies of boot data).

Storage device 192 may include, for example, a second storage device such as a non-volatile memory express (NVMe) solid-state drive. Storage device 192 may include a boot partition (e.g., 193) that may be a portion of storage resources of storage device 192 allocated for storage of boot data (e.g., a latest stable copy of the boot data, bootloader files, configuration files, etc.). Boot partition 193 may, for example, be isolated from other memory sections of storage device 192.

While described with respect to boot partition 193 storing boot data, it will be appreciated that any other type of data may be stored in boot partition 193 without departing from embodiments disclosed herein.

Boot partition 193 may be cooperatively established by storage device 192 and management controller 152. For example, management controller 152 may provide instructions to storage device 192 to create boot partition 193, and storage device 192 may create boot partition 193 in response. Boot partition 193 may be established in such a way that management controller 152 is permitted by storage device 192 to access boot partition 193 (e.g., permitted to read, write, and/or otherwise modify data stored in boot partition 193) and no other entity of the data processing system may be permitted by storage device 192 to access boot partition 193. For example, if a software component hosted by processor 190 (e.g., the BIOS, other software programs) requests access to boot partition 193, storage device 192 may deny the request. As a result, any entity desiring access to boot partition 193 may be required to provide a request to management controller 152. Refer to the description of FIG. 2C for additional details about limiting access to the boot partition by the storage device.

Management controller 152 may operate independently from and may be distinct from hardware resources 150. To communicate with hardware resources 150 and implement management functionalities, management controller 152 may utilize side band channels (e.g., 174A-174C). For example, management controller 152 may communicate with storage device 192 via side band channel 174C. For additional details regarding management controller 152 and side band channels of the data processing system, refer to the description of FIG. 1B.

To execute instructions indicated by the boot data, hardware resources 150 may include processor 190. Processor 190 may include a central processing unit (CPU) and/or any other type of processor that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

Processor 190 may host any number and/or type of entities, which may include an operating system, drivers, applications, and/or any other type of software program that may provide computer-implemented services. As part of performing their functionality, the entities may perform operations with respect to at least a portion of boot data stored in boot partition 193. The operations may include: (i) reading the at least the portion of the boot data from boot partition 193, (ii) writing the at least the portion of the boot data to boot partition 193, and/or (iii) other operations (e.g., deleting, modifying, and/or executing the at least the portion of the boot data). In order to perform the operations, processor 190 may provide a request to management controller 152 via side band channel 174A. Management controller 152 may, presuming the request is not denied, access the boot data by communicating with storage device 192 via side band channel 174C. Requests provided by processor 190 to storage device 192 via in-band channels 171 may be denied. Refer to the description of FIGS. 2A-2C for additional details.

To further clarify embodiments disclosed herein, interaction diagrams in accordance with an embodiment are shown in FIGS. 2A-2C. The interaction diagrams may illustrate an example of how data may be obtained and used within the systems of FIGS. 1A-1C. In the examples shown in FIGS. 2A-2C, a data processing system (e.g., 100A) may include components such as hardware resources 150 and management controller 152. Hardware resources 150 may include processor 190 and storage device 192. The components of the data processing system may be similar to and/or include functionality similar to those described with respect to FIGS. 1A-1C.

In the interaction diagram, processes performed by and interactions between components of a system in accordance with an embodiment are shown. In the diagram, components of the system are illustrated using a first set of shapes (e.g., 152, 190, etc.), located towards the top of each figure. Lines descend from these shapes. Processes performed by the components of the system are illustrated using a second set of shapes (e.g., 202, 208, etc.) superimposed over these lines. Interactions (e.g., communication, data transmissions, etc.) between the components of the system are illustrated using a third set of shapes (e.g., 200, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur. Lines shown in dashing may indicate that the interactions may or may not occur.

Generally, the processes and interactions are temporally ordered in an example order, with time increasing from the top to the bottom of each page. For example, the interaction labeled as 200 may occur prior to the interaction labeled as 204. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur when an entity hosted by hardware resources of data processing system 100A (e.g., processor 190) provides a request to write at least a portion of boot data to a boot partition included in a storage device of the data processing system (e.g., storage device 192). Refer to the description of FIG. 1C for additional details regarding the boot partition (e.g., boot partition 193).

For example, an entity (e.g., a software program, driver, etc.) hosted by processor 190 may provide write request 200 to management controller 152. Write request 200 may include: (i) information regarding the operation the entity intends to perform (e.g., writing at least a portion of boot data to the boot partition), (ii) at least one characteristic for the entity (e.g., identification data), (iii) the at least the portion of the boot data for which the entity intends to perform the operation (e.g., a file name, a file type, other characteristics of the at least the portion of the boot data), and/or (iv) other information.

Processor 190 may provide the write request by (i) transmission via a message, (ii) storing in a storage with subsequent retrieval by management controller 152, (iii) a publish-subscribe system where management controller 152 subscribes to updates from processor 190 thereby causing a copy of the write request to be propagated to management controller 152, and/or (iv) other processes. The request may be provided, for example, via side band channel 174A.

Upon obtaining write request 200, management controller 152 may perform permission analysis process 202. During permission analysis process 202, management controller 152 may perform a permission analysis process for the entity to determine whether the entity is authorized to initiate performance of the operation with respect to the at least the portion of the boot data. To do so, management controller 152 may obtain at least one characteristic for the entity. The at least one characteristic for the entity may be included as part of write request 200, and/or management controller may obtain the at least one characteristic for the entity by providing identification data request 204 to processor 190.

Identification data request 204 may include a request for the at least one characteristic for the entity, which may include: (i) a feature globally unique identifier (GUID) for the entity, (ii) a predefined role and/or classification for the entity, (iii) other attributes for the entity, and/or (iv) any other characteristics for the entity. Management controller 152 may provide identification data request 204 by (i) transmission via a message, (ii) storing in a storage with subsequent retrieval by processor 190, (iii) a publish-subscribe system where processor 190 subscribes to updates from management controller 152 thereby causing a copy of the identification data request to be propagated to processor 190, and/or (iv) other processes. The identification data request may be provided, for example, via side band channel 174A.

Processor 190 may read the request and obtain a response to the request, the response including the identification data (e.g., the at least one characteristic for the entity). Processor 190 may provide the identification data to management controller 152 at interaction 206 by (i) transmission via a message, (ii) storing in a storage with subsequent retrieval by management controller 152, (iii) a publish-subscribe system where management controller 152 subscribes to updates from processor 190 thereby causing a copy of the identification data to be propagated to management controller 152, and/or (iv) other processes. The identification data may be provided, for example, via side band channel 174A.

Using the identification data (e.g., obtained as part of write request 200 and/or identification data 206), management controller 152 may continue performance of permission analysis process 202. Management controller 152 may determine whether the entity is authorized to initiate performance of the operation based on at least: (i) the at least one characteristic (e.g., at least a portion of the identification data), (ii) the operation (e.g., writing, reading, deleting, modifying, and/or executing the at least the portion of the boot data), (iii) the at least the portion of the boot data (e.g., based on the file name, file type, and/or other information regarding the at least the portion of the boot data), (iv) data access limitations for data stored in the storage device, and/or (v) other information.

The data access limitations for data stored in the storage device may be managed by management controller 152 and may include a schema (e.g., a list, policy, schema, rule set, table) usable to determine permissions of entities to initiate performance of operations with respect to portions of the boot data. For example, the data access limitations may be generated by a management system of the data processing system (e.g., management system 102, refer to FIG. 1A) and may be provided to management controller 152 for use. The data access limitations may include any type of access limitation mechanisms, including: (i) access control lists (ACLs), (ii) role-based access control (RBAC), (iii) discretionary access control (DAC), (iv) mandatory access control (MAC), (v) attribute-based access control (ABAC), and/or (vi) any other type of access limitation mechanisms.

For example, a flash recovery feature (e.g., the entity) hosted by processor 190 may provide a request to management controller 152 to write a system configuration file to the boot partition of storage device 192. Management controller 152 may obtain at least one characteristic for the flash recovery feature, such as the feature GUID. Using the feature GUID, the operation (e.g., writing data to the boot partition), the at least the portion of the boot data which the flash recovery feature intends to write (e.g., the system configuration file), and an access control list, management controller 152 may determine whether the flash recovery feature is authorized to perform the operation. For example, the access control list may include a table of feature GUIDs and corresponding permissions for each of the feature GUIDS. Using the access control list, management controller 152 may determine that the flash recovery feature is not permitted to write the system configuration file to the boot partition. In this example, management controller 152 may determine that the flash recovery feature is not authorized to initiate performance of the operation with respect to the at least the portion of the boot data.

If management controller 152 determines that the entity is not authorized to initiate performance of the operation with respect to the at least the portion of the boot data, management controller 152 may prevent the entity from initiating performance of the operation with respect to the at least the portion of the boot data. For example, management controller 152 may: (i) provide a response to write request 200 to processor 190 indicating that the request was denied, (ii) not allow the entity to write the at least the portion of the boot data to the boot partition, (iii) notify another entity (e.g., a user of data processing system 100A) that the request was denied, and/or (iv) perform other actions.

If management controller 152 determines that the entity is authorized to initiate performance of the operation with respect to the at least the portion of the boot data, management controller 152 may perform operation facilitation process 208. During operation facilitation process 208, management controller 152 may facilitate performance of the operation with respect to the at least the portion of the boot data to facilitate provisioning of computer-implemented services by data processing system 100A.

To facilitate performance of the operation, management controller 152 may initiate interaction 210. During interaction 210, management controller 152 may obtain, via a first side band channel of data processing system 100A (e.g., side band channel 174A), the at least the portion of the boot data from the entity to facilitate writing the at least the portion of the boot data to the boot partition.

To obtain the at least the portion of the boot data, management controller 152 may provide a request to processor 190 for the at least the portion of the boot data to be written to the boot partition of storage device 192. Management controller 152 may provide the request by (i) transmission via a message, (ii) storing in a storage with subsequent retrieval by processor 190, (iii) a publish-subscribe system where processor 190 subscribes to updates from management controller 152 thereby causing a copy of the request to be propagated to processor 190, and/or (iv) other processes.

Processor 190 may read the request and provide the at least the portion of the boot data in response. Processor 190 may provide the response to management controller 152 by (i) transmission via a message, (ii) storing in a storage with subsequent retrieval by management controller 152, (iii) a publish-subscribe system where management controller 152 subscribes to updates from processor 190 thereby causing a copy of the response to be propagated to management controller 152, and/or (iv) other processes. The response may be provided, for example, via side band channel 174A.

While described with respect to management controller 152 providing a request for the at least the portion of the boot data to processor 190 and obtaining the at least the portion of the boot data in response, it will be appreciated that the at least the portion of the boot data may be included as part of write request 200. If the at least the portion of the boot data is included in write request 200, operation facilitation process 208 may proceed without interaction 210.

Using the at least the portion of the boot data, management controller 152 may provide the at least the portion of the boot data to storage device 192 at interaction 212 for storage in the boot partition. At interaction 212, management controller 152 may also provide to storage device 192: (i) instructions for writing the at least the portion of the boot data to the boot partition, (ii) an identifier, characteristic, and/or any other information usable by storage device 192 to identify that the at least the portion of the boot data is being provided by management controller 152, and/or (iii) other information.

Management controller 152 may provide the at least the portion of the boot data to storage device 192 via a second side band channel of data processing system 100A (e.g., side band channel 174C). Management controller 152 may provide the at least the portion of the boot data to storage device 192 by (i) transmission via a message, (ii) storing in a storage with subsequent retrieval by storage device 192, (iii) a publish-subscribe system where storage device 192 subscribes to updates from management controller 152 thereby causing a copy of the at least the portion of the boot data to be propagated to storage device 192, and/or (iv) other processes.

Upon obtaining the at least the portion of the boot data (and identifying that the at least the portion of the boot data was provided by management controller 152), storage device 192 may write the at least the portion of the boot data to the boot partition.

Turning to FIG. 2B, a second interaction diagram in accordance with an embodiment is shown. The second interaction diagram may illustrate processes and interactions that may occur when an entity hosted by hardware resources of data processing system 100A (e.g., processor 190) provides a request to read at least a portion of boot data to a boot partition included in a storage device of the data processing system (e.g., storage device 192). Refer to the description of FIG. 1C for additional details regarding the boot partition (e.g., boot partition 193).

For example, an entity (e.g., a software program, driver, etc.) hosted by processor 190 may provide read request 220 to management controller 152. Read request 220 may include: (i) information regarding the operation the entity intends to perform (e.g., reading at least a portion of boot data to the boot partition), (ii) at least one characteristic for the entity (e.g., identification data), (iii) the at least the portion of the boot data for which the entity intends to perform the operation (e.g., a file name, a file type, other characteristics of the at least the portion of the boot data), and/or (iv) other information.

Processor 190 may provide the read request by (i) transmission via a message, (ii) storing in a storage with subsequent retrieval by management controller 152, (iii) a publish-subscribe system where management controller 152 subscribes to updates from processor 190 thereby causing a copy of the read request to be propagated to management controller 152, and/or (iv) other processes. The read request may be provided, for example, via side band channel 174A.

Upon obtaining read request 220, management controller 152 may perform permission analysis process 222. Permission analysis process 222 may be similar to permission analysis process 202 described in FIG. 2A. During permission analysis process 222, management controller 152 may perform a permission analysis process for the entity to determine whether the entity is authorized to initiate performance of the operation with respect to the at least the portion of the boot data. To do so, management controller 152 may obtain at least one characteristic for the entity. The at least one characteristic for the entity may be included as part of read request 220, and/or management controller may obtain the at least one characteristic for the entity by providing identification data request 224 to processor 190.

Identification data request 224 may include a request for the at least one characteristic for the entity, which may include: (i) a feature globally unique identifier (GUID) for the entity, (ii) a predefined role and/or classification for the entity, (iii) other attributes for the entity, and/or (iv) any other characteristics for the entity. Management controller 152 may provide identification data request 224 by (i) transmission via a message, (ii) storing in a storage with subsequent retrieval by processor 190, (iii) a publish-subscribe system where processor 190 subscribes to updates from management controller 152 thereby causing a copy of the identification data request to be propagated to processor 190, and/or (iv) other processes. The identification data request may be provided, for example, via side band channel 174A.

Processor 190 may read the request and obtain a response to the request, the response including the identification data (e.g., the at least one characteristic for the entity). Processor 190 may provide the identification data to management controller 152 at interaction 226 by (i) transmission via a message, (ii) storing in a storage with subsequent retrieval by management controller 152, (iii) a publish-subscribe system where management controller 152 subscribes to updates from processor 190 thereby causing a copy of the identification data to be propagated to management controller 152, and/or (iv) other processes. The identification data may be provided, for example, via side band channel 174A.

Using the identification data (e.g., obtained as part of read request 220 and/or identification data 226), management controller 152 may continue performance of permission analysis process 222. Management controller 152 may determine whether the entity is authorized to initiate performance of the operation based on at least: (i) the at least one characteristic (e.g., at least a portion of the identification data), (ii) the operation (e.g., writing, reading, deleting, modifying, and/or executing the at least the portion of the boot data), (iii) the at least the portion of the boot data (e.g., based on the file name, file type, and/or other information regarding the at least the portion of the boot data), (iv) data access limitations for data stored in the storage device, and/or (v) other information. For additional details regarding the data access limitations and/or using the data access limitations to determine whether the entity is authorized to initiate performance of the operation with respect to the at least the portion of the boot data, refer to the description of FIG. 2A.

If management controller 152 determines that the entity is not authorized to initiate performance of the operation with respect to the at least the portion of the boot data, management controller 152 may prevent the entity from initiating performance of the operation with respect to the at least the portion of the boot data. For example, management controller 152 may: (i) provide a response to read request 220 to processor 190 indicating that the request was denied, (ii) not allow the entity to read the at least the portion of the boot data from the boot partition, (iii) notify another entity (e.g., a user of data processing system 100A) that the request was denied, and/or (iv) perform other actions.

If management controller 152 determines that the entity is authorized to initiate performance of the operation with respect to the at least the portion of the boot data, management controller 152 may perform operation facilitation process 228. During operation facilitation process 228, management controller 152 may facilitate performance of the operation with respect to the at least the portion of the boot data to facilitate provisioning of computer-implemented services by data processing system 100A.

To facilitate performance of the operation, management controller 152 may obtain a copy of the at least the portion of the boot data from the boot partition from storage device 192 at interaction 230. Management controller 152 may provide a request for the copy of the at least the portion of the boot data to storage device 192, the request including: (i) instructions for obtaining the copy of the at least the portion of the boot data from the boot partition, (ii) an identifier, characteristic, and/or any other information usable by storage device 192 to identify that the request is being provided by management controller 152, and/or (iii) other information.

Management controller 152 may provide the request for the copy of the at least the portion of the boot data via side band channel 174C by (i) transmission via a message, (ii) storing in a storage with subsequent retrieval by storage device 192, (iii) a publish-subscribe system where storage device 192 subscribes to updates from management controller 152 thereby causing a copy of the request to be propagated to storage device 192, and/or (iv) other processes.

Storage device 192 may read the request and provide the copy of the at least the portion of the boot data to management controller 152 in response. Storage device 192 may provide the response to management controller 152 via side band channel 174C by (i) transmission via a message, (ii) storing in a storage with subsequent retrieval by management controller 152, (iii) a publish-subscribe system where management controller 152 subscribes to updates from storage device 192 thereby causing a copy of the response to be propagated to management controller 152, and/or (iv) other processes.

Upon obtaining the copy of the at least the portion of the boot data, management controller 152 may provide the copy of the at least the portion of the boot data to processor 190 at interaction 232 to be read by the entity. Management controller 152 may provide the copy of the at least the portion of the boot data to processor 190 by (i) transmission via a message, (ii) storing in a storage with subsequent retrieval by processor 190, (iii) a publish-subscribe system where processor 190 subscribes to updates from management controller 152 thereby causing the copy of the at least the portion of the boot data to be propagated to processor 190, and/or (iv) other processes. The copy of the at least the portion of the boot data may be provided, for example, via side band channel 174A.

Thus, the processes and interactions shown in FIGS. 2A-2B may be used to facilitate performance of an operation by an entity hosted by hardware resources of a data processing system with respect to at least a portion of boot data stored in a boot partition of a storage device of the hardware resources. To facilitate performance of the operation, a management controller of the data processing system may perform a permission analysis for the entity to determine whether the entity is authorized to initiate performance of the operation. If the entity is authorized, the management controller may facilitate performance of the operation.

Turning to FIG. 2C, a third interaction diagram in accordance with an embodiment is shown. The third interaction diagram may illustrate processes and interactions that may occur when an entity hosted by hardware resources of data processing system 100A (e.g., processor 190) provides a request to perform an operation with respect to at least a portion of boot data stored in a boot partition to a storage device of data processing system 100A (e.g., storage device 192). Refer to the description of FIG. 1C for additional details regarding the boot partition (e.g., boot partition 193).

For example, an entity (e.g., a software program, driver, etc.) hosted by processor 190 may provide request 240 to storage device 192. Request 240 may include: (i) information regarding the operation the entity intends to perform (e.g., reading, writing, deleting, modifying, and/or executing) with respect to at least a portion of boot data stored in a boot partition of storage device 192, (ii) identification data for the entity, such as a feature GUID, (iii) the at least the portion of the boot data for which the entity intends to perform the operation (e.g., a file name, a file type, other characteristics of the at least the portion of the boot data), and/or (iv) other information.

Processor 190 may provide the request by (i) transmission via a message, (ii) storing in a storage with subsequent retrieval by storage device 192, (iii) a publish-subscribe system where storage device 192 subscribes to updates from processor 190 thereby causing a copy of the request to be propagated to storage device 192, and/or (iv) other processes. The request may be provided, for example, via an in-band communication channel such as in-band channel 171A.

Upon obtaining request 240, storage device 192 may perform permission analysis process 242. During permission analysis process 242, storage device 192 may perform a permission analysis process for the entity to determine whether the entity is authorized to initiate performance of the operation with respect to the at least the portion of the boot data. To do so, storage device 192 may use the identification data for the entity. For example, storage device 192 may use the identification data to determine whether the entity: (i) is management controller 152, or (ii) is not management controller 152.

The boot partition may be established in a manner that restricts access to the boot partition to management controller 152 (e.g., management controller 152 may be the only entity granted access to the boot data by storage device 192). As a result, other entities may not be permitted by storage device 192 to access the boot data, and requests to perform operations with respect to portions of the boot data obtained by storage device 192 from the other entities may be denied by storage device 192.

For example, during permission analysis process 242 storage device 192 may determine that the entity is not management controller 152 using the identification data. As a result, storage device 192 may determine that the entity is not authorized to access the at least the portion of the boot data. Storage device 192 may provide a response to processor 190 at interaction 244, and the response may include an indication that the request was denied.

Storage device 192 may provide the response by: (i) transmission via a message, (ii) storing in a storage with subsequent retrieval by processor 190, (iii) a publish-subscribe system where processor 190 subscribes to updates from storage device 192 thereby causing a copy of the response to be propagated to processor 190, and/or (iv) other processes. The response may be provided, for example, via in-band channel 171A.

While described with respect to storage device 192 performing a permission analysis process after obtaining a request from processor 190, it will be appreciated that the permission analysis process may be performed after obtaining a request from any other entity, including management controller 152, without departing from embodiments disclosed herein. In an instance in which the request is obtained from management controller 152, storage device 192 may approve the request.

Thus, the processes and interactions shown in FIG. 2C may occur when an entity that is not a management controller of a data processing system requests to perform an operation with respect to a portion of boot data stored in a boot partition of a storage device. Because the boot partition may be established in such a way that only the management controller is permitted to access the boot data, requests from other entities of the data processing system obtained by the storage device may be denied. In doing so, the management controller may restrict access to the boot data to authorized entities based on data access limitations and/or any other policy.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2C may perform various methods to manage the operation of data processing systems. FIG. 3 illustrates a method that may be performed by the components of the system of FIGS. 1A-2C. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system, any component of a data processing system (e.g., a management controller, hardware resources) and/or another device.

Turning to FIG. 3, a flow diagram illustrating a method in accordance with an embodiment is shown. The flow diagram may illustrate various operations performed while managing operation of a data processing system. The data processing system may include hardware resources and a management controller, and may be similar to the data processing system discussed with respect to FIGS. 1A-1C.

At operation 300, a management controller of the data processing system may obtain, from an entity hosted by hardware resources of the data processing system, a request to perform an operation with respect to at least a portion of boot data stored in a storage device of the hardware resources. Obtaining the request may include: (i) receiving the request via a message from the entity (e.g., via a side band channel of the data processing system), (ii) reading the request from a storage location used by the entity, (iii) receiving the request via a publish-subscribe system (e.g., by subscribing to updates from the entity), and/or (iv) other methods.

At operation 302, the management controller may perform a permission analysis process for the entity to determine whether the entity is authorized to initiate performance of the operation with respect to the at least the portion of the boot data. Performing the permission analysis process may include: (i) obtaining, by the management controller and via a side band channel of the data processing system, at least one characteristic for the entity, (ii) making, by the management controller, a determination regarding whether the entity is authorized to initiate performance of the operation based on at least the at least one characteristic, the operation, the at least the portion of the boot data, and data access limitations for data stored in the storage device, (iii) providing the request to another entity responsible for performing the permission analysis process and receiving the determination in response, and/or (iv) other methods.

Obtaining the at least one characteristic for the entity may include: (i) reading the at least one characteristic from the request, (ii) providing a request for the at least one characteristic to the entity and receiving the at least one characteristic from the entity in response, (iii) reading the at least one characteristic from storage, (iv) receiving the at least one characteristic from another entity, and/or (v) other methods.

Making the determination regarding whether the entity is authorized to perform the operation may include: (i) identifying the operation from the request (e.g., reading the operation from the request), (ii) identifying the at least the portion of the boot data indicated by the request (e.g., reading a file name and/or file type from the request), (iii) obtaining the data access limitations (e.g., receiving the data access limitations from another entity such as a remote entity, reading the data access limitations from storage), (iv) using the data access limitations to determine whether the entity is authorized to initiate performance of the operation, and/or (v) other methods.

Using the data access limitations to determine whether the entity is authorized to initiate performance of the operation may include: (i) performing a search using the data access limitations and the at least one characteristic for the entity as a key for the search, (ii) identifying, as a result of the search, an entry in the data access limitations (e.g., from a table, list, rule set and/or other type of schema) corresponding to the entity, (iii) making a determination, using data included in the entry, the operation, and the at least the portion of the boot data, regarding whether the entity is authorized to initiate performance of the operation with respect to the at least the portion of the boot data, and/or (iv) other methods.

At operation 304, it may be determined whether the entity is authorized to initiate performance of the operation with respect to the at least the portion of the boot data. Making the determination may include: (i) reading a result of the permission analysis process for the entity, (ii) receiving the determination from another entity, and/or (iii) other methods.

If it is determined that the entity is authorized to initiate performance of the operation with respect to the at least the portion of the boot data (e.g., the determination is “Yes” at operation 304), then the method may proceed to operation 306.

At operation 306, the management controller may facilitate performance of the operation with respect to the at least the portion of the boot data to facilitate provisioning of computer-implemented services by the data processing system. For example, if the operation includes writing the at least the portion of the boot data to the boot partition, facilitating performance of the operation may include: (i) obtaining, by the management controller and via a first side band channel of the data processing system, the at least the portion of the boot data from the entity to facilitate writing the at least the portion of the boot data to the boot partition, (ii) providing, by the management controller and via a second side band channel of the data processing system, the at least the portion of the boot data to the storage device, (iii) storing the at least the portion of the boot data in another storage with subsequent retrieval by the storage device, (iv) providing the at least the portion of the boot data to another entity to provide the at least the portion of the boot data to the storage device, and/or (v) other methods.

Obtaining the at least the portion of the boot data from the entity may include: (i) providing a request for the at least the portion of the boot data to the entity and receiving the at least the portion of the boot data in response, (ii) reading the at least the portion of the boot data from the request to perform the operation, (iii) reading the at least the portion of the boot data from storage, (iv) receiving the at least the portion of the boot data from another entity, and/or (v) other methods.

Providing the at least the portion of the boot data to the storage device may include:
(i) transmitting the at least the portion of the boot data to the storage device via a message, (ii) storing the at least the portion of the boot data in another storage with subsequent retrieval by the storage device, (iii) providing the at least the portion of the boot data to another entity responsible for providing the at least the portion of the boot data to the storage device, and/or (iv) other methods.

In another example, if the operation includes reading the at least the portion of the boot data from the boot partition, facilitating performance of the operation may include: (i) providing, by the management controller, a request for a copy of the at least the portion of the boot data to the storage device, (ii) receiving, by the management controller, the copy of the at least the portion of the boot data in response, (iii) providing, by the management controller, the copy of the at least the portion of the boot data to the entity, and/or (iv) other methods.

The method may end following operation 306.

Returning to operation 304, if it is determined that the entity is not authorized to initiate performance of the operation with respect to the at least the portion of the boot data (e.g., the determination is “No” at operation 304), then the method may proceed to operation 308.

At operation 308, the management controller may prevent the entity from initiating performance of the operation with respect to the at least the portion of the boot data. Preventing the entity from initiating performance of the operation may include: (i) providing a response to the entity indicating that the request was denied, (ii) not allowing the entity to access the at least the portion of the boot data to perform the operation, (iii) notifying another entity (e.g., a user of the data processing system, a remote entity) that the request was denied, and/or (iv) other methods.

The method may end following operation 308.

Thus, as illustrated above, embodiments disclosed herein may provide systems and methods usable to manage operation of a data processing system using a management controller of the data processing system. The management controller may manage access to boot data stored in a boot partition of a storage device of the data processing system. By using the management controller to manage access to the boot data, data access limitations (e.g., RBAC, ACL, etc.) may be used to restrict access to the boot data to authorized entities (e.g., unauthorized entities may be prevented from accessing the boot data). In doing so, a likelihood of the boot data being accessed by unauthorized and/or malicious entities may be reduced. As a result, a likelihood of the data processing system becoming compromised may also be reduced, and the data processing system may provide computer-implemented services as desired.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS® /iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining, by a management controller of the data processing system and from an entity hosted by hardware resources of the data processing system, a request to perform an operation with respect to at least a portion of boot data stored in a storage device of the hardware resources;
performing, by the management controller, a permission analysis process for the entity to determine whether the entity is authorized to initiate performance of the operation with respect to the at least the portion of the boot data; and
in an instance of the performing in which the entity is authorized to initiate performance of the operation:
facilitating, by the management controller, performance of the operation with respect to the at least the portion of the boot data to facilitate provisioning of computer-implemented services by the data processing system.

2. The method of claim 1, wherein performing the permission analysis process comprises:
obtaining, by the management controller and via a side band channel of the data processing system, at least one characteristic for the entity; and
making, by the management controller, a determination regarding whether the entity is authorized to perform the operation based on at least the at least one characteristic, the operation, the at least the portion of the boot data, and data access limitations for data stored in the storage device.

3. The method of claim 2, wherein the data access limitations are managed by the management controller, and comprise a schema usable to determine permissions of entities to perform operations with respect to portions of the boot data.

4. The method of claim 1, wherein the boot data is stored in a boot partition of the storage device, the boot partition being a portion of storage resources of the storage device allocated for storage of boot data.

5. The method of claim 4, wherein the boot partition is cooperatively established by the management controller and the storage device.

6. The method of claim 5, wherein the management controller is permitted by the storage device to access the boot partition and no other entity of the data processing system is permitted by the storage device to access the boot partition.

7. The method of claim 6, wherein the operation comprises at least one type of operation selected from a list consisting of:
reading the at least the portion of the boot data from the boot partition; and
writing the at least the portion of the boot data to the boot partition.

8. The method of claim 7, wherein facilitating performance of the operation with respect to the at least the portion of the boot data comprises:
obtaining, by the management controller and via a first side band channel of the data processing system, the at least the portion of the boot data from the entity to facilitate writing the at least the portion of the boot data to the boot partition; and
providing, by the management controller and via a second side band channel of the data processing system, the at least the portion of the boot data to the storage device.

9. The method of claim 1, further comprising:
in an instance of the performing in which the entity is not authorized to initiate performance of the operation with respect to the at least the portion of the boot data:
preventing, by the management controller, the entity from initiating performance of the operation with respect to the at least the portion of the boot data.

10. The method of claim 1, wherein the entity is not permitted by the storage device to access the boot data, and requests to perform operations with respect to portions of the boot data obtained by the storage device from the entity are denied by the storage device.

11. The method of claim 1, wherein the management controller operates independently from and is distinct from the hardware resources.

12. The method of claim 1, wherein the storage device is a non-volatile memory express (NVMe) solid-state drive.

13. A non-transitory machine-readable medium having instructions stored therein, which when executed by a processor, cause the processor to perform operations for managing operation of a data processing system, the operations comprising:
obtaining, by a management controller of the data processing system and from an entity hosted by hardware resources of the data processing system, a request to perform an operation with respect to at least a portion of boot data stored in a storage device of the hardware resources;
performing, by the management controller, a permission analysis process for the entity to determine whether the entity is authorized to initiate performance of the operation with respect to the at least the portion of the boot data; and
in an instance of the performing in which the entity is authorized to initiate performance of the operation:
facilitating, by the management controller, performance of the operation with respect to the at least the portion of the boot data to facilitate provisioning of computer-implemented services by the data processing system.

14. The non-transitory machine-readable medium of claim 13, wherein performing the permission analysis process comprises:
obtaining, by the management controller and via a side band channel of the data processing system, at least one characteristic for the entity; and
making, by the management controller, a determination regarding whether the entity is authorized to perform the operation based on at least the at least one characteristic, the operation, the at least the portion of the boot data, and data access limitations for data stored in the storage device.

15. The non-transitory machine-readable medium of claim 14, wherein the data access limitations are managed by the management controller, and comprise a schema usable to determine permissions of entities to perform operations with respect to portions of the boot data.

16. The non-transitory machine-readable medium of claim 15, wherein the boot data is stored in a boot partition of the storage device, the boot partition being a portion of storage resources of the storage device allocated for storage of boot data.

17. A data processing system, comprising:
a processor; and
a memory coupled to the processor to store instructions, which when executed by the processor, cause the processor to perform operations for managing operation of a data processing system, the operations comprising:
obtaining, by a management controller of the data processing system and from an entity hosted by hardware resources of the data processing system, a request to perform an operation with respect to at least a portion of boot data stored in a storage device of the hardware resources;
performing, by the management controller, a permission analysis process for the entity to determine whether the entity is authorized to initiate performance of the operation with respect to the at least the portion of the boot data; and
in an instance of the performing in which the entity is authorized to initiate performance of the operation:
facilitating, by the management controller, performance of the operation with respect to the at least the portion of the boot data to facilitate provisioning of computer-implemented services by the data processing system.

18. The data processing system of claim 17, wherein performing the permission analysis process comprises:
obtaining, by the management controller and via a side band channel of the data processing system, at least one characteristic for the entity; and
making, by the management controller, a determination regarding whether the entity is authorized to perform the operation based on at least the at least one characteristic, the operation, the at least the portion of the boot data, and data access limitations for data stored in the storage device.

19. The data processing system of claim 18, wherein the data access limitations are managed by the management controller, and comprise a schema usable to determine permissions of entities to perform operations with respect to portions of the boot data.

20. The data processing system of claim 19, wherein the boot data is stored in a boot partition of the storage device, the boot partition being a portion of storage resources of the storage device allocated for storage of boot data.
